(19) United States
(12) Patent Application Publication
(10) Pub. No.: US 2026/0010165 A1
(43) Pub. Date: Jan. 8, 2026

(54) AUTONOMOUS MOBILE DEVICE, AUTONOMOUS MOVEMENT IMPROVEMENT SYSTEM, AND METHOD FOR IMPROVING MOVEMENT OF AUTONOMOUS MOBILE DEVICE

(71) Applicant: ROHM CO., LTD., Kyoto-shi (JP)

(72) Inventors: Hiroshi YAGUMA, Kyoto-shi (JP); Ken NAKAHARA, Kyoto-shi (JP)

(21) Appl. No.: 19/327,029

(22) Filed: Sep. 12, 2025

Related U.S. Application Data
(63) Continuation of application No. PCT/JP2024/008303, filed on Mar. 5, 2024.

(30) Foreign Application Priority Data
Mar. 20, 2023 (JP) 2023-044150

(51) Int. Cl. G05D 1/622; G05D 101/10; G06V 10/94; G06V 20/52; G06V 20/58

(52) U.S. Cl. CPC G05D 1/622; G06V 10/95; G06V 20/53; G06V 20/58; G05D 2101/10

(57) ABSTRACT

A movement improvement method for an autonomous moving apparatus that autonomously moves based on a received signal and an autonomous movement algorithm, the method comprising: acquiring data of a signal received by the autonomous moving apparatus and an image captured by a camera mounted on the autonomous moving apparatus; identifying the data of the signal and the image in a predetermined movement state of the autonomous moving apparatus; and changing the autonomous movement algorithm of the autonomous moving apparatus, based on the identified data of the signal and the image.

### CROSS REFERENCE TO RELATED APPLICATIONS

This application is a continuation under 35 U.S.C. § 120 of PCT/JP2024/008303, filed on Mar. 5, 2024, which is incorporated herein by reference, and which claims priority to Japan Patent Application No. 2023-044150 filed on Mar. 20, 2023. The present application likewise claims priority under 35 U.S.C. § 119 to Japanese Application No. 2023-044150, Mar. 20, 2023, the entire content of which is also incorporated herein by reference.

### TECHNICAL FIELD

The present disclosure relates to an autonomous moving apparatus, an autonomous movement system, and a movement improvement method for an autonomous moving apparatus.

### BACKGROUND

An autonomous moving apparatus is known, which receives a radio wave of a beacon output from a target object and an acoustic wave reflected by an obstacle, and autonomously moves to the target object based on the radio wave and the acoustic wave, while avoiding obstacles (see Patent Literature 1).
Patent Literature 1: WO 2022/181488

### BRIEF DESCRIPTION OF DRAWINGS

FIG. 1 is a plan view for explaining an outline of a digital pheromone, which is a mechanism in which an autonomous moving apparatus 100 reaches a target object (transmitting apparatus) 200, while avoiding obstacles J1 and J2.

FIG. 2 is a plan view for explaining an outline of echolocation, which is a mechanism in which the autonomous moving apparatus 100 reaches a target object (destination) P1, while avoiding obstacles p1 to p4.

FIG. 3 is a block diagram showing a detailed configuration of the autonomous moving apparatus 100 according to an embodiment.

FIG. 4 is a block diagram showing details of constituent elements for implementing an echolocation function of the autonomous moving apparatus 100 of FIG. 3.

FIG. 5 is a block diagram showing an example of a data flow in the autonomous movement system according to Example 2.

FIG. 6 is a block diagram showing an example of a data flow in the autonomous moving apparatus 100 according to Example 1.

FIG. 7 is a flowchart showing an example of the movement improvement method for the autonomous moving apparatus 100.

### DETAILED DESCRIPTION

### (Autonomous Moving Apparatus and Autonomous Movement System)

An outline of an autonomous moving apparatus and an autonomous movement system according to an embodiment of the present disclosure, which autonomously move to a target object while avoiding obstacles, will be described below.

It should be noted that embodiments described below show exhaustive or specific examples. Numerical values, shapes, materials, constituent elements, and installation positions and connection forms of constituent elements described in the following embodiments are examples and are not intended to be limited to those of the present disclosure. Further, among constituent elements in the following embodiments, constituent elements not recited in independent claims indicating the most significant concept are described as optional constituent elements. Still further, the dimensional ratios in the drawings are exaggerated for illustrative purposes and may differ from the actual ratios. In addition, the following embodiments and modified examples thereof may include similar constituent elements, and therefore the similar constituent elements are denoted with a common reference numeral to omit duplicated descriptions thereof.

An autonomous moving apparatus has a configuration of autonomously reaching a target object, and can be used in the internal space or, in some cases, in the external space of buildings such as houses and offices and structures such as factories, for example. Further, by using a propeller or the like which enables aerial movement for a moving mechanism, a flying object such as what is referred to as a drone can autonomously reach a target object, for example. Further, the autonomous moving apparatus can be used for moving objects such as vehicles including passenger cars and buses, aircraft, spacecraft, ships, and submersibles. In the embodiments, a description will be given by taking, as examples, vehicles with wheels such as passenger cars and buses.

The autonomous moving apparatus does not use an imaging device such as a camera, Light Detection And Ranging (LiDAR), and radar, but reaches the target object using a signal output by the target object, while avoiding an obstacle. Although there are no particular limitations, examples of the signal output by the target object include an acoustic wave, a radio wave, or a high-frequency electromagnetic wave. Hereinafter, a description will be given by taking a radio wave as an example. The autonomous moving apparatus receives a radio wave such as a beacon using a plurality of antennas thereof, uses a technique for estimating an incoming direction of the radio wave to estimate a direction of the target object which emits the radio wave, and moves in the estimated direction. If an obstacle is present outside a line-of-sight between the target object and the autonomous moving apparatus, the autonomous moving apparatus may move in an incoming direction of a radio wave reflected by the obstacle. However, the autonomous moving apparatus may receive a radio wave directly received from the target object during movement. In this case, the autonomous moving apparatus can change a movement direction thereof in a direction of the target object on the way to move toward the obstacle. As a result, the autonomous moving apparatus can move toward the target object, while avoiding the obstacle. In addition, if an obstacle is present on the line-of-sight between the target object and the autonomous moving apparatus, the autonomous moving apparatus can detect the presence of the obstacle, because the reception intensity of a radio wave oscillates as the autonomous moving apparatus moves toward the obstacle. In this way, the autonomous moving apparatus can reach the target object, while avoiding the obstacle, by continuously moving in a direction where the reception intensity of the radio waves is high, while estimating an incoming direction of a radio wave.

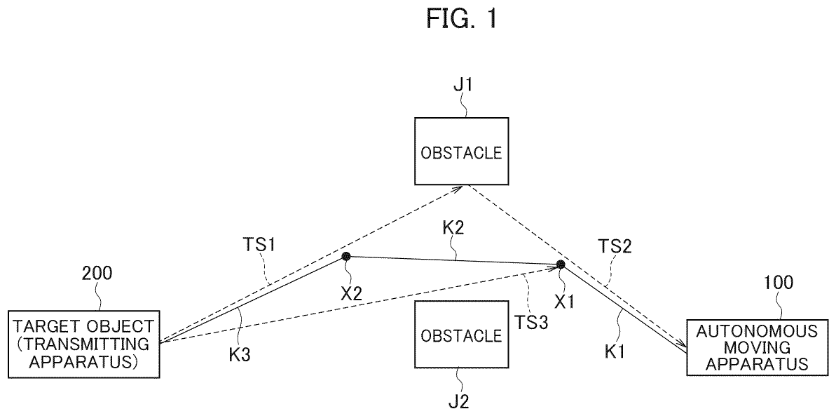

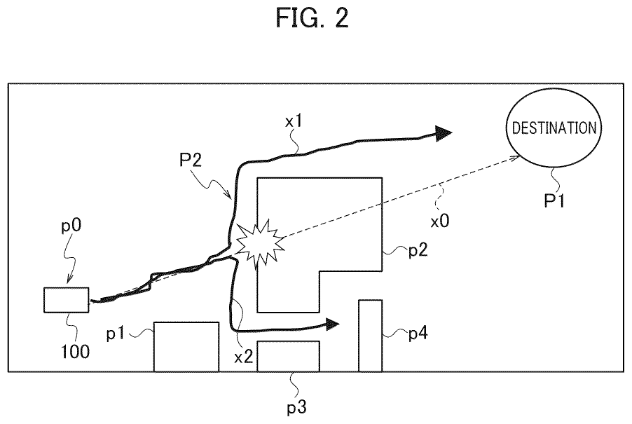

With reference to FIG. 1 and FIG. 2, a general description will be given regarding an outline of an autonomous movement system 1000 including an autonomous moving apparatus 100 and a target object 200.

### (Outline of Digital Pheromone)

With reference to FIG. 1, an outline of a digital pheromone will be described, which is a mechanism in which the autonomous moving apparatus 100 reaches a target object (transmitting apparatus 200) while avoiding obstacles J1 and J2, by continuously moving in a direction where the reception intensity of a radio wave is high, while estimating an incoming direction of the radio wave. The autonomous moving apparatus 100 receives a radio wave transmitted from a transmitting apparatus of the target object 200. The line-of-sight between the autonomous moving apparatus 100 and the target object 200 is blocked by the obstacle J2. Therefore, the autonomous moving apparatus 100 receives the radio wave via a path K3→a path K2→a path K1. There is a possibility that the autonomous moving apparatus 100 receives a radio wave from the line-of-sight direction also, depending on the size of the obstacle J2 and a frequency of a beacon; however, it is assumed that a radio wave received via the path K1 has the highest intensity. The autonomous moving apparatus 100 estimates an incoming direction of a radio wave with the highest intensity using a plurality of antennas mounted on the autonomous moving apparatus 100, and moves based on the estimated incoming direction.

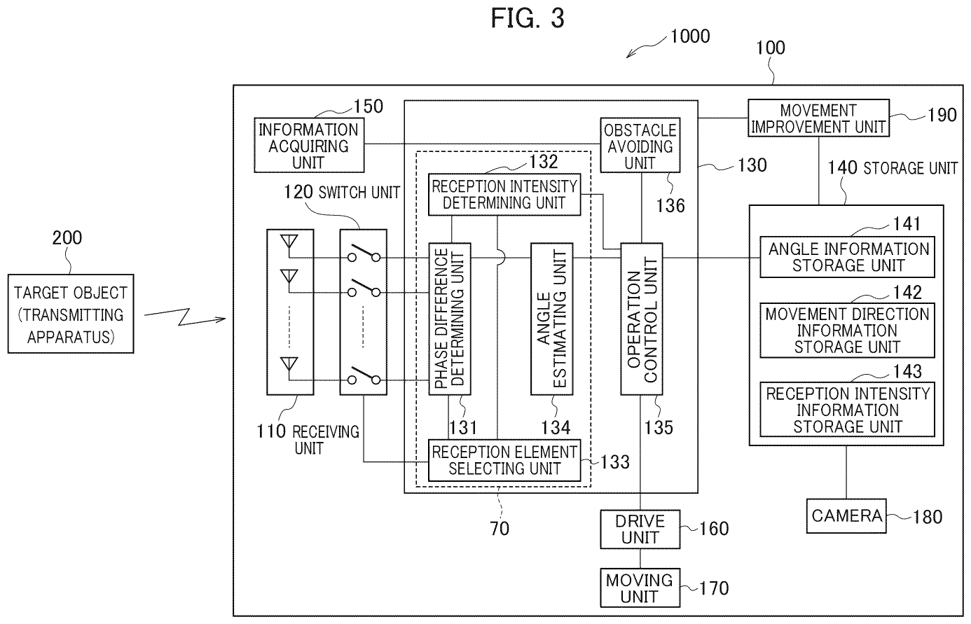

The autonomous moving apparatus 100 moving on the path K1 toward the obstacle J1 continuously moves on the path K1 toward the obstacle J1, because the reception intensity of a radio wave increases as the autonomous moving apparatus 100 approaches the obstacle J1. However, when the autonomous moving apparatus 100 reaches a position X1, the transmitting apparatus 200 appears ahead of the line-of-sight of the autonomous moving apparatus 100, and therefore the autonomous moving apparatus 100 can directly receive a radio wave TS3. Since the reception intensity of the radio wave TS3 is higher than that of a radio wave TS2 at the position X1, the autonomous moving apparatus 100 attempts to change a movement direction to an incoming direction of the radio wave TS3. The autonomous moving apparatus 100 can move on the line of the incoming direction of the radio wave TS3, but in that case, there is a possibility that the autonomous moving apparatus 100 collides with the obstacle J2. Therefore, from the fact that the radio wave TS3 could not be received up to the position X1 on the path K1, and from the estimated incoming direction of the high-intensity radio wave TS3 received at the position X1, the autonomous moving apparatus 100 recognizes the presence of the obstacle J2 and moves in the direction of the path K2. The autonomous moving apparatus 100 moving in the direction of the path K2 recognizes the presence of the obstacle J1 and estimates the path K3, from the fact that the incoming direction of the radio wave output from the transmitting apparatus 200 gradually widens with respect to the traveling direction of the autonomous moving apparatus 100, and the fact that the movement direction was changed at the position X1. Therefore, the autonomous moving apparatus 100 can change the traveling direction toward the transmitting apparatus 200 at a position X2 and can reach the transmitting apparatus 200. WO 2022/181488 also discloses a detailed configuration example for implementing the digital pheromone configuration of the autonomous moving apparatus 100 described above, and the detailed configuration example will be described later with reference to FIG. 3 of the present specification.

### (Outline of Echolocation)

With reference to FIG. 2, an outline of echolocation will be described, which is a mechanism in which the autonomous moving apparatus 100 reaches a destination P1, which is a target object, while selecting a suitable travel path which is less affected by obstacles p1 to p4. FIG. 2 is an explanatory diagram showing a situation in which the autonomous moving apparatus 100 travels on a planar travel path where a plurality of obstacles p1 to p4 are present, and moves toward the destination P1.

When the autonomous moving apparatus 100 autonomously moves from a position p0 to the destination P1, an obstacle p2 is present on a travel path x0, which is the shortest path. In this case, the autonomous moving apparatus 100 outputs an acoustic wave in a traveling direction, and receives the acoustic wave reflected by a surface of the obstacle p2. The autonomous moving apparatus 100 detects the obstacle p2 from the received acoustic wave, and changes a movement direction at a position P2 in front of the obstacle p2 to avoid a collision with the obstacle p2. The acoustic wave received by the autonomous moving apparatus 100 is an example of a signal received by the autonomous moving apparatus 100. Signals received by the autonomous moving apparatus 100 include a radio wave such as a beacon, and an acoustic wave reflected from an obstacle.

At this time, it is desirable that the autonomous moving apparatus 100 change the movement direction to the left to avoid the obstacle p2. That is, because a travel path x1 on the left side of the obstacle p2 as viewed from the autonomous moving apparatus 100 side is an open space, the autonomous moving apparatus 100 can travel without being restricted by obstacles. However, a travel path x2 on the right side of the obstacle p2 is intricate and complicated, and the autonomous moving apparatus 100 will be subject to more restrictions by obstacles when traveling. Therefore, it is preferable to change the movement direction of the autonomous moving apparatus 100 to the left.

Meanwhile, the travel path x2 on the right side of the obstacle p2 is intricate and complicated, and the autonomous moving apparatus 100 will be subject to more restrictions by obstacles when traveling. More specifically, a) when an obstacle is in the immediate vicinity of an antenna, a phase shift occurs and the accuracy of direction detection is significantly reduced. Also, b) when the autonomous moving apparatus 100 enters such a complicated space with many obstacles, there is a problem that the reflection of radio waves becomes complicated and the autonomous moving apparatus 100 cannot get out.

The autonomous moving apparatus 100 receives sound reflected by surrounding objects (obstacles p1 to p4) using a pair of left and right microphones. By comparing the left and right audio signals, the autonomous moving apparatus 100 can avoid a complicated space where many obstacles p1 to p4 are intricately located, and travel through an open space without being restricted by surrounding objects to reach the destination P1. A more specific method will be described later.

### (Details of Autonomous Moving Apparatus)

With reference to FIG. 3, the detailed configuration of the autonomous moving apparatus 100 will be described. The autonomous moving apparatus 100 includes a receiving unit 110, a switch unit 120 for selecting reception elements of the receiving unit 110, a control unit 130, a storage unit 140, an information acquiring unit 150, a drive unit 160, and a moving unit 170. The moving unit 170 such as a wheel, a belt, a caterpillar, or a propeller is driven by means of drive information output from the drive unit 160 shown in FIG. 3, so that the autonomous moving apparatus 100 moves. The receiving unit 110 has a plurality of reception elements. A camera 180 and a movement improvement unit 190 shown in FIG. 3 will be described later in “Movement improvement of autonomous moving apparatus using camera image.”

The receiving unit 110 is an antenna which receives a radio wave including a high-frequency electromagnetic wave, output from a transmitting apparatus 200. For example, the receiving unit 110 is an array antenna constituted by a plurality of antenna elements, which are an example of reception elements. An array of the antenna elements constituting the array antenna may be an arbitrary array.

The switch unit 120 is a switch configured to select any of the reception elements of the receiving unit 110, and output a radio wave received by the reception element. Therefore, the number of switches constituting the switch unit 120 is equal to the number of the reception elements of the receiving unit 110, and one switch corresponds to one reception element. If the receiving unit 110 is the array antenna, a plurality of antenna elements are selected, and information on the intensity, phase, and the like of radio waves received by the plurality of antenna elements is output to a phase difference determining unit 131 and a reception intensity determining unit 132, which will be described later, for example. The switch unit 120 may be a semiconductor switch, but the switch unit 120 is not limited thereto, and it is possible to employ a switch which can open and close an electrical connection of any configuration.

The control unit 130 can be implemented using a microcomputer including a Central Processing Unit (CPU). A computer program (autonomous movement program) for causing the microcomputer to function as the control unit 130 is installed in the microcomputer and is executed. As a result, the microcomputer functions as a plurality of information processing units of the control unit 130.

The control unit 130 includes, as the plurality of information processing units, the phase difference determining unit 131, the reception intensity determining unit 132, a reception element selecting unit 133, an angle estimating unit 134, an operation control unit 135, and an obstacle avoiding unit 136. The control unit 130 causes the autonomous moving apparatus 100 to move, based on signals (including a radio wave signal and an acoustic wave signal) received by the receiving unit 110 and the information acquiring unit 150 and an autonomous movement algorithm described below.

The phase difference determining unit 131 analyzes received signals from the plurality of reception elements of the receiving unit 110 selected by the reception element selecting unit 133, and determines phase differences between the received signals from the differences in arrival times between the received signals. The determined phase differences are output to the angle estimating unit 134. Further, if the autonomous moving apparatus 100 stops or moves, the phase difference determining unit 131 can also determine one angle from the plurality of phase differences between the plurality of received signals.

The reception intensity determining unit 132 determines the reception intensity from the plurality of reception elements of the receiving unit 110 selected by the reception element selecting unit 133. The estimated reception intensity is output to the operation control unit 135. Further, the estimated reception intensity may be output to the reception element selecting unit 133. The reception intensity may be expressed in an arbitrary unit related to the reception intensity, and may be expressed as relative information. The reception intensity may be output to the operation control unit 135 and the reception element selecting unit 133 as reception intensity information in any format.

The reception element selecting unit 133 simultaneously selects one or more reception elements that receive a radio wave, among the plurality of reception elements included in the receiving unit 110. In order that the phase difference determining unit 131 determines the phase difference, the reception element selecting unit 133 simultaneously selects a plurality of reception elements. Further, the reception element selecting unit 133 may sequentially switch and select the plurality of reception elements, and the reception intensity determining unit 132 may determine one or more reception elements with high reception intensity. It is possible that the angle estimating unit 134 estimates an incoming direction of a radio wave and the like via the phase difference determining unit 131, based on signals received by the one or more reception elements determined to have high reception intensity.

The angle estimating unit 134 can adopt any incoming direction estimation method using an array antenna. For example, the angle estimating unit 134 can adopt an estimation method in which a pair of antenna elements is used, a complex reception response to an incoming wave is obtained in advance from the phase difference of the two antenna elements forming the pair, an evaluation function is introduced, and an angle at which an evaluation function value is maximum is set as an incoming direction of a radio wave. The angle estimating unit 134 can estimate an incoming direction of a radio wave from the phase difference of a plurality of antenna elements. A Multiple Signal Classification (MUSIC) and Root-MUSIC method using eigenvalues and eigenvectors of a correlation matrix can be adopted, for example. Further, an Estimation of Signal Parameters via Rotational Invariance Techniques (ESPRIT) method can be adopted. The angle estimated in this way is stored in an angle information storage unit 141 of the storage unit 140 as angle information from an arbitrary reference axis. Still further, the estimated angle information may be stored in the angle information storage unit 141, in association with the reception intensity determined by the reception intensity determining unit 132. The estimated angle information may also be stored in the angle information storage unit 141, in association with the determined reception intensity and time information. The time information may be received by the receiving unit 110 from the outside of the autonomous moving apparatus 100, and the autonomous moving apparatus 100 can perform timing using a timing unit (not shown).

There may be a plurality of angles estimated by the angle estimating unit 134. If there are a plurality of angles estimated, the angle estimating unit 134 may receive the reception intensity at each angle from the reception intensity determining unit 132, associate each angle with the reception intensity, and store the information in the angle information storage unit 141. For example, as described with reference to FIG. 1, the autonomous moving apparatus 100 at the position X1 receives a radio wave reflected by the obstacle J1 and a radio wave propagated on the line-of-sight at different angles. A radio wave reflected by the obstacle J1 may also be reflected by another obstacle J2 and received by the autonomous moving apparatus 100 at a different angle. In this way, the reflected wave from the obstacle may reach the autonomous moving apparatus 100 after being reflected multiple times. Basically, the autonomous moving apparatus 100 moves in a direction where the reception intensity is large; however, there is a possibility that an obstacle prevents the autonomous moving apparatus 100 from moving in the direction where the reception intensity is high, or a path is wrong. In this way, there is also a possibility that the autonomous moving apparatus 100 may not avoid moving in a direction of another reflected wave. For this reason, if the plurality of angles are estimated, the autonomous moving apparatus 100 may associate each angle with the reception intensity, and store the information in the angle information storage unit 141.

The operation control unit 135 generates movement direction information including a movement direction for moving the autonomous moving apparatus 100, in response to the magnitude or change of the reception intensity of the radio wave signal determined by the reception intensity determining unit 132, and an incoming direction of a radio wave estimated by the angle estimating unit 134. In the embodiment, the obstacle avoiding unit 136 determines that there is an obstacle or a complicated space in the periphery of the autonomous moving apparatus 100, based on an acoustic wave signal received by the information acquiring unit 150 which will be described later. In this case, the operation control unit 135 generates the movement direction information, assuming that the reliability degree (I) of an estimation result by the angle estimating unit 134 and/or a determination result by the reception intensity determining unit 132 is lower than a predetermined reference value. That is, when the reliability degree (I) is lower than the predetermined reference value, the operation control unit 135 controls the autonomous moving apparatus 100 so as to move by avoiding the periphery of an obstacle or a complicated space in the periphery of the autonomous moving apparatus 100. The reliability degree (I) is a coefficient that becomes smaller when an obstacle or a complicated space is present in the periphery of the autonomous moving apparatus 100, and becomes smaller as a distance from the autonomous moving apparatus 100 to the obstacle or the complicated space becomes shorter. The reliability degree (I) is a coefficient applied to the estimation result by the angle estimating unit 134 and the determination result by the reception intensity determining unit 132.

The operation control unit 135 may generate the movement direction information by performing weighting on an estimated incoming direction of a radio wave according to the reliability degree (I), for example. More specifically, the operation control unit 135 may multiply the reception intensity (R) of a plurality of estimated incoming directions of radio waves by the reliability degree (I), to obtain a product (R×I), and may control the autonomous moving apparatus 100 to move in an incoming direction where the product (R×I) is large. A case is not limited to a case where a plurality of incoming directions of radio waves can be estimated at the same time, but a plurality of incoming directions of radio waves may be compared in the past history. That is, the operation control unit 135 may generate the movement direction information by weighting an incoming direction of a radio wave stored in the storage unit 140, by an index according to the reliability degree (I). In addition, if the reliability degree (I) deteriorates, the operation control unit 135 may control the autonomous moving apparatus 100 to move in a space or direction where the reliability degree (I) is high.

There are various methods for a method in which the operation control unit 135 determines that the reliability degree (I) is low, due to the presence of an obstacle or a complicated space in the periphery of the autonomous moving apparatus 100. The operation control unit 135 may determine the reliability degree (I) based on at least one of the magnitude, the change, the number of reception times, the left-right comparison, and the comparison with the past history of a received signal, as well as an estimated distance to an obstacle, the shape of a space or a passage, the reception intensity, the amount of noise, and the stability of an incoming direction angle, for example. The “received signal” includes the radio wave signal received by the receiving unit 110 and the acoustic wave signal received by the information acquiring unit 150. If the reception intensity determined by the reception intensity determining unit 132 oscillates periodically in an estimated incoming direction of a radio wave, the operation control unit 135 may determine that an obstacle is present in the estimated incoming direction, and lower the reliability degree (I). This is because, when the reception intensity oscillates periodically, there is a possibility that an obstacle is present in the periphery of the autonomous moving apparatus 100 or between the autonomous moving apparatus 100 and a target object, and a diffracted wave is received.

In order for the operation control unit 135 to determine a peripheral obstacle or an intricate and complicated space, the autonomous moving apparatus 100 may include the obstacle avoiding unit 136 for measuring a direction of an obstacle and a distance to the obstacle. The information acquiring unit 150 may be an infrared sensor, an ultrasonic sensor, or a depth sensor. Furthermore, when the operation control unit 135 receives contact prediction information or contact information from the obstacle avoiding unit 136, the operation control unit 135 may determine that the reliability degree (I) is low, and change the movement direction so as to avoid the obstacle or intricate complicated space. In this case, the changed direction may be maintained temporarily or for a predetermined period of time.

In this way, the operation control unit 135 can associate an index according to the reliability degree (I), an incoming direction and the reception intensity of a radio wave, and the history of control contents of the autonomous moving apparatus 100, and store the information in the storage unit 140; the operation control unit 135 can generate movement direction information, in consideration of the time transition of the histories. The operation control unit 135 can associate a movement direction, a movement time or a movement distance in the movement direction, and the reliability degree (I), and store the information in a movement direction information storage unit 142. As described above, from the above described information stored in the movement direction information storage unit 142, the operation control unit 135 can calculate the past movement history, and generate map information; this enables the autonomous moving apparatus 100 to move by avoiding the periphery of an obstacle or a complicated space with a low reliability degree (I).

Further, if the radio wave intensity is very low, and if an incoming direction of a radio wave may not be estimated by the angle estimating unit 134, the operation control unit 135 may move, while maintaining the current movement direction. This is because, if a null point occurs due to interference between an emitted radio wave and a reflected radio wave, it may be possible to estimate an incoming direction of a radio wave again by the autonomous moving apparatus 100 moving to another point, for example.

Further, the operation control unit 135 can perform machine learning or deep learning using the movement history, angle information, an estimated radio wave direction, and the reliability degree (I), and store machine learning results and deep learning results in the storage unit 140. Therefore, the operation control unit 135 causes the storage unit 140 to store the history of the reliability degree (I) and the movement direction as teaching data. Still further, the machine learning results and the deep learning results can be stored in the storage unit 140, in association with the movement direction, angle information, an estimated radio wave direction, and the reliability degree (I).

The obstacle avoiding unit 136 determines whether there is a possibility that the autonomous moving apparatus 100 contacts an obstacle, based on an acoustic wave signal received by the information acquiring unit 150. The information acquiring unit 150 transmits the acoustic wave signal to the obstacle avoiding unit 136. The obstacle avoiding unit 136 transmits contact prediction information to the operation control unit 135, if the obstacle avoiding unit 136 expects that the autonomous moving apparatus 100 contacts the obstacle, based on the movement direction and size of the autonomous moving apparatus 100, and the obtained information on the obstacle. Further, the obstacle avoiding unit 136 transmits contact information to the operation control unit 135, if the obstacle avoiding unit 136 determines that the autonomous moving apparatus 100 contacts the obstacle. The operation control unit 135 determines the reliability degree (I) according to the contact prediction information or the contact information.

The storage unit 140 is a computer-readable storage medium. The storage unit 140 may be a Read Only Memory (ROM) or an Erasable Programmable ROM (EPROM), for example. Further, the storage unit 140 may be an Electrically Erasable Programmable ROM (EEPROM), a Random Access Memory (RAM), a hard disk, or the like.

The storage unit 140 includes the angle information storage unit 141, the movement direction information storage unit 142, and a reception intensity information storage unit 143. Hereinafter, a description will be given regarding information processed by the control unit 130 among information stored in the storage unit 140. The storage unit 140 also stores data of the radio wave signal received by the receiving unit 110.

The angle information storage unit 141 stores angle information of a radio wave of which an incoming direction is estimated by the angle estimating unit 134. The angle information may be information from a predetermined reference axis, and the reference axis is determined based on a physical outline of the autonomous moving apparatus 100. The outline may be expressed in two-dimensional relative coordinates other than a space in which the autonomous moving apparatus 100 moves, and a line expressed by the relative coordinates may be used as the reference axis, for example. The angle information may be stored, in association with estimated radio wave reception intensity and time information at which the angle information is estimated.

The movement direction information storage unit 142 can store a movement direction which is determined by the operation control unit 135, and in which the autonomous moving apparatus 100 actually moves, in association with time information at which movement of the autonomous moving apparatus 100 in the movement direction starts, and time information at which the movement of the autonomous moving apparatus 100 in the movement direction ends. In addition, the time information at which the movement of the autonomous moving apparatus 100 in the movement direction starts, or the time information at which the movement of the autonomous moving apparatus 100 in the movement direction ends, and time information at which the autonomous moving apparatus 100 is moving in the movement direction may be stored in the movement direction information storage unit 142, in association with the movement direction information. The operation control unit 135 may reproduce the past movement path of the autonomous moving apparatus 100 based on the pieces of information. In order that the autonomous moving apparatus 100 may reach a target object, the operation control unit 135 can select a path which prevents the autonomous moving apparatus 100 from travelling along the same movement path, with reference to the past movement path. The obstacle avoiding unit 136 may also estimate a position of an obstacle with reference to the past movement path. Machine learning results and deep learning results, which are results obtained by performing machine learning or deep learning, may be stored in the storage unit 140 including the movement direction information storage unit 142. The machine learning results and the deep learning results may be stored, in association with the movement direction, angle information, an estimated radio wave direction, and information of the reliability degree (I).

The reception intensity information storage unit 143 stores the reception intensity of radio waves received by a plurality of reception elements, the intensity being determined by the reception intensity determining unit 132. The reception intensity information storage unit 143 stores the reception intensity of the radio waves in a radio wave incoming direction estimated by the plurality of reception elements. The reception intensity is stored in the reception intensity information storage unit 143 in association with time information at which the reception intensity is determined.

The drive unit 160 includes a mechanism for driving the moving unit 170 to move the autonomous moving apparatus 100 in a movement direction determined by the operation control unit 135. The drive unit 160 includes a mechanism for rotating a wheel, if the moving unit 170 is the wheel, a mechanism for turning a caterpillar, if the moving unit 170 is the caterpillar, and a mechanism for rotating a propeller, if the moving unit 170 is the propeller, for example. The drive unit 160 is not limited to the above aspects, but the drive unit 160 can have any driving configuration which drives a configuration of the moving unit 170.

The moving unit 170 is a portion constituting means for moving the autonomous moving apparatus 100. If the autonomous moving apparatus 100 is a vehicle, the moving unit 170 may be a wheel including a tire, a caterpillar, or the like. Further, if the autonomous moving apparatus 100 is a flying object such as a drone or a helicopter, the moving unit 170 may be a propeller. The moving unit 170 is not limited to the above aspects, but the moving unit 170 can have any moving mechanism capable of moving the autonomous moving apparatus 100.

### (Details of Echolocation)

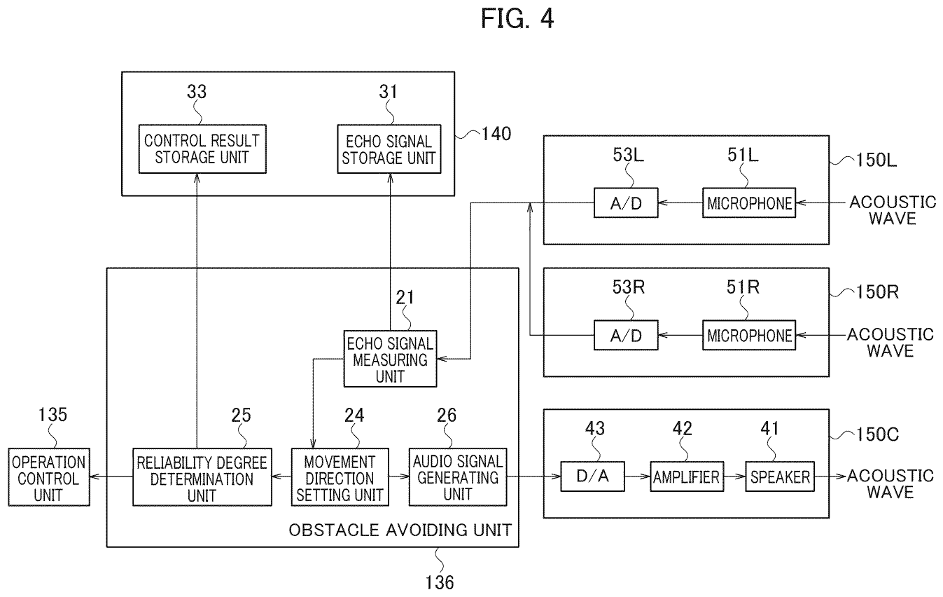

The information acquiring unit 150 may be a device including one or more speakers and two or more microphones. As an example, a device including one speaker and two microphones will be described with reference to FIG. 4. FIG. 4 is a block diagram showing details of each constituent element in an echolocation configuration.

As shown in FIG. 4, the information acquiring unit 150 includes, as one form thereof, one audio transmitting unit 150C and two audio receiving units 150L and 150R.

The audio transmitting unit 150C is attached to a vehicle body of the autonomous moving apparatus 100, and transmits an acoustic wave toward an area including the front of the vehicle body (positive direction of an X-axis). The audio transmitting unit 150C includes a speaker 41, an amplifier 42, and a D/A conversion unit 43. Although an example in which one audio transmitting unit 150C is provided will be described with reference to FIG. 4, a plurality of audio transmitting units 150C may be provided. For example, when sound emitted from the audio transmitting unit 150C does not reach the entire periphery of the autonomous moving apparatus 100, two audio transmitting units 150C may be provided on the left and right sides of the autonomous moving apparatus 100.

The audio transmitting unit 150C outputs an acoustic wave having an ultrasonic frequency or a frequency in a human audible band. The audio transmitting unit 150C may also be configured to output an acoustic wave having a frequency other than an ultrasonic frequency and a frequency in an audible band. The “acoustic wave” refers to a general term for an elastic wave that propagates regardless of a gas, a liquid, or a solid.

The audio transmitting unit 150C outputs an acoustic wave at a predetermined cycle or irregularly. The audio transmitting unit 150C also has a function of changing a frequency of a transmitted acoustic wave. That is, when the frequency of an acoustic wave generated by an audio signal generating unit 26, which will be described later, is changed, an acoustic wave having the changed frequency is transmitted. When a plurality of audio transmitting units 150C are provided, timing at which the audio transmitting units 150C output acoustic waves can be synchronized.

The D/A conversion unit 43 converts a digital audio signal generated by the control unit 130, which will be described later, into an analog signal. The sound includes a human audible frequency, an ultrasonic wave higher than the audible frequency, and an infrasound lower than the audible frequency. The sound is an example of an acoustic wave.

The amplifier 42 amplifies the analog audio signal. When an ultrasonic speaker is used as the speaker 41, a rectangular wave of a digital output can be directly output. That is, a logic output may be used instead of an analog output, and a buffer circuit may be provided instead of the D/A conversion unit 43 and the amplifier 42.

The speaker 41 outputs an analog audio signal amplified by the amplifier 42 as an acoustic wave. The speaker 41 is installed to face, for example, a straight traveling direction of the autonomous moving apparatus 100, and outputs an acoustic wave toward the straight traveling direction of the autonomous moving apparatus 100. That is, the audio transmitting unit 150C outputs an acoustic wave toward one reference direction (for example, the straight traveling direction) of the autonomous moving apparatus 100. A range in which the speaker 41 outputs an acoustic wave only needs to include the straight traveling direction of the autonomous moving apparatus 100, and a central axis of the speaker 41 may be different from the straight traveling direction (front) of the autonomous moving apparatus 100. Hereinafter, the “straight traveling direction” may be referred to as “front.”

The audio receiving unit 150L and the audio receiving unit 150R are attached to the vehicle body of the autonomous moving apparatus 100, receive an acoustic wave reflected by an object in the periphery of the autonomous moving apparatus 100, and convert the acoustic wave into an electric signal. The audio receiving unit 150L (acoustic wave receiving unit) is provided to face a left side with respect to the front of the autonomous moving apparatus 100. The audio receiving unit 150R (acoustic wave receiving unit) is provided to face a right side with respect to the front of the autonomous moving apparatus 100. That is, two audio receiving units are arranged, and are arranged to face symmetrical directions with respect to one reference direction (for example, the front) of the autonomous moving apparatus 100.

One audio receiving unit 150L receives an acoustic wave on the left side with respect to the front of the autonomous moving apparatus 100. The other audio receiving unit 150R receives an acoustic wave on the right side with respect to the front of the autonomous moving apparatus 100. The two audio receiving units 150L and 150R are a plurality of acoustic wave receiving units having different input directions of acoustic waves. Each of the audio receiving units 150L and 150R includes a respective microphone 51L, 51R and a respective A/D conversion unit 53L, 53R.

The microphones 51L and 51R receive an acoustic wave reflected by an object and convert the acoustic wave into an audio signal as an electric signal. A left microphone 51L is provided to face a left direction by, for example, 30 degrees with respect to the front of the autonomous moving apparatus 100. A right microphone 51R is provided to face a right direction by, for example, 30 degrees with respect to the front of the autonomous moving apparatus 100.

Each of the microphones 51L and 51R only needs to be arranged so as to sandwich the speaker 41 in a left-right direction perpendicular to the front of the autonomous moving apparatus 100. In other words, the speaker 41 only needs to be located between the microphones 51L and 51R in a vehicle width direction. The orientations of the microphones 51L and 51R are not limited to any angle, as long as the orientations are between the front and the left-right direction of the autonomous moving apparatus 100. The two microphones 51L and 51R may be provided to face different directions. When the autonomous moving apparatus 100 moves in a three-dimensional space, such as a drone, the audio receiving units may be provided at four locations on the left, right, top, and bottom of the autonomous moving apparatus 100, for example. In this case, the microphones are preferably installed at four locations on the top, bottom, left, and right of the front side of the autonomous moving apparatus 100.

The A/D conversion units 53L and 53R digitize analog audio signals output from the microphones 51L and 51R, respectively, and output the digital audio signals to the control unit 130.

The storage unit 140 includes an echo signal storage unit 31 and a control result storage unit 33.

The echo signal storage unit 31 stores an echo signal measured by an echo signal measuring unit 21, which will be described later. Here, the “echo signal” is a phenomenon in which a sound is reflected by a surface of a certain object and is heard again, and is a concept including “reverberation,” which is a phenomenon in which a sound is continuously heard because reflection from a ceiling, a wall, or the like is repeated even after a sound source stops vibrating.

The obstacle avoiding unit 136 calculates a movement direction and a reliability degree (I) for avoiding an obstacle and a complicatedly intricate space based on the echo signals received by the audio receiving units 150R and 150L and various movement control algorithms described below, and transmits the movement direction and the reliability degree (I) to the operation control unit 135 as a control signal. The obstacle avoiding unit 136 includes the echo signal measuring unit 21, a movement direction setting unit 24, a reliability degree determination unit 25, and the audio signal generating unit 26.

The audio signal generating unit 26 generates an audio signal having a predetermined frequency, and outputs the generated audio signal to the audio transmitting unit 150C at a predetermined time interval (for example, at an interval of one second).

The audio signal generating unit 26 changes the frequency of the audio signal as necessary. For example, when another moving device transmits an audio signal in addition to the autonomous moving apparatus 100, and the frequency of this audio signal and the frequency of an audio signal transmitted by the audio transmitting unit 150C of the autonomous moving apparatus 100 are approximate or identical, the frequency of the audio signal transmitted from the audio transmitting unit 150C is changed so as to be different from the audio signal transmitted from the other moving device.

The echo signal measuring unit 21 receives the audio signals output from the A/D conversion units 53L and 53R, and transfers the audio signals to both the echo signal storage unit 31 and the movement direction setting unit 24.

When an obstacle is present in a direction in which the autonomous moving apparatus 100 moves, the movement direction setting unit 24 analyzes the audio signal transferred from the echo signal measuring unit 21 and each piece of data stored in the echo signal storage unit 31 and the control result storage unit 33, and sets the movement direction of the autonomous moving apparatus 100. The movement direction setting unit 24 calculates movement information such as a turning direction, a turning angle, and a movement speed of the autonomous moving apparatus 100. When there are a plurality of incoming directions of the echo signal, the movement direction setting unit 24 does not set a movement direction, but provides various pieces of information such as the plurality of incoming directions to the reliability degree determination unit 25.

The reliability degree determination unit 25 determines a reliability degree (I) based on various pieces of information and the like obtained from the movement direction setting unit 24, and outputs various control signals such as the reliability degree to the operation control unit 135. The control signals include information related to driving, such as a movement direction, a turning direction, a turning angle, and a traveling speed, in addition to the reliability degree (I).

The reliability degree determination unit 25 outputs the control signal output to the drive unit 160 to the control result storage unit 33. The control result storage unit 33 stores the control signal output from the reliability degree determination unit 25.

Next, a method, performed by the movement direction setting unit 24, for setting a movement direction when the autonomous moving apparatus 100 avoids an obstacle will be described.

### (First Setting Method)

The movement direction setting unit 24 sets the movement direction of the autonomous moving apparatus 100 based on a received echo signal. The movement direction setting unit 24 outputs information on the set movement direction to the reliability degree determination unit 25.

For example, when the autonomous moving apparatus 100 autonomously travels from the position p0 to the destination P1 shown in FIG. 2, and the obstacle p2 is present on the travel path x0, which is the shortest path, the autonomous moving apparatus 100 changes the movement direction at the position P2 in front of the obstacle p2 to avoid the obstacle p2. At this time, the travel path x2 on the right side of the obstacle p2 is a complicatedly intricate space, and the autonomous moving apparatus 100 is subject to more restrictions by obstacles when traveling. Therefore, it is preferable to change the movement direction of the autonomous moving apparatus 100 to the left. Therefore, the obstacle avoiding unit 136 of FIG. 4 determines a peripheral obstacle and a complicated space, calculates a reliability degree (I), and provides a control signal including the reliability degree (I) to the operation control unit 135.

### (Second Setting Method)

The movement direction setting unit 24 acquires a past received echo signal stored in the echo signal storage unit 31 and a past control signal stored in the control result storage unit 33.

The movement direction setting unit 24 performs machine learning based on the past control signal output by the reliability degree determination unit 25 for each of the left and right audio receiving units 150L and 150R. By performing machine learning, the movement direction setting unit 24 acquires a correlation between the echo signal and the movement direction when the autonomous moving apparatus 100 avoids an obstacle. Since machine learning is a well-known technique, a detailed description thereof will be omitted.

The movement direction setting unit 24 sets an optimal movement direction of the autonomous moving apparatus 100 based on the acquired correlation, and the reliability degree determination unit 25 determines a reliability degree (I) based on a machine learning result.

The reliability degree determination unit 25 sets movement information such as a movement direction, a turning direction, a turning angle, and a movement speed of the autonomous moving apparatus 100 using the machine learning result based on the past control results, and outputs a control signal to the operation control unit 135 together with the reliability degree (I). As a result, when the autonomous moving apparatus 100 travels while avoiding an obstacle, a more open travel path can be selected to cause the autonomous moving apparatus 100 to travel.

According to the above configuration, in the autonomous moving apparatus 100, it is possible to dispense with Simultaneous Localization And Mapping (SLAM) that requires an expensive device such as Light Detection And Ranging (LiDAR), thereby allowing a simple configuration and reducing manufacturing cost. In addition, when the autonomous moving apparatus 100 is introduced to a new location, and each time a layout of a previous location is changed, it is not necessary to create a map of the location or layout, and an introduction cost can also be reduced. It is also not necessary to predetermine a travel route plan. It is not necessary to lay a magnetic tape, a magnetic rod, or a two-dimensional code for guidance on a floor surface as in the case of an Automatic Guided Vehicle (AGV). An enormous amount of data calculation processing and an expensive computer associated therewith, as required for an Autonomous Mobile Robot (AMR), are not required, and power consumption can also be suppressed.

The autonomous moving apparatus 100 may also have a short distance measuring sensor for preventing contact with an obstacle that appears in the immediate vicinity (for example, within 50 cm), or a bumper sensor or a contact sensor for detecting collision with an obstacle. When the autonomous moving apparatus 100 is applied to an automatic guided vehicle, it is needless to say that the autonomous moving apparatus 100 has a function that satisfies the provision related to ISO3691-4/JIS D 6802 “Automatic guided vehicles and systems-Safety requirements and verification” related to the safety of an automatic guided vehicle.

### (Movement Improvement of Autonomous Moving Apparatus Using Camera Image)

Hereinafter, the movement improvement of the autonomous moving apparatus 100 using a camera image will be described. As described with reference to FIG. 1 to FIG. 4, the autonomous moving apparatus 100 autonomously moves to the target object 200 while avoiding obstacles, based on a radio wave signal received by the receiving unit 110, an echo signal (an example of an acoustic wave signal) received by the information acquiring unit 150, and a movement control algorithm of the control unit 130. Since a radio wave signal and an acoustic wave signal are wave signals, it is difficult to clearly grasp the shape of an obstacle or the like from only the radio wave signal and the acoustic wave signal. Therefore, it is not easy to analyze the movement result of the autonomous moving apparatus 100 from only the radio wave signal and the acoustic wave signal recorded in the storage unit 140 and feed back the analysis result to the movement control algorithm executed by the control unit 130.

Therefore, in the embodiment, an autonomous moving apparatus 100, an autonomous movement system, and a movement improvement method for the autonomous moving apparatus 100 will be described, which accurately improve the movement of the autonomous moving apparatus 100 by combining data of at least one of a radio wave signal and an acoustic wave signal with an image captured by a camera 180 mounted on the autonomous moving apparatus 100. The autonomous moving apparatus 100 can acquire an image of the periphery of the autonomous moving apparatus 100 using the camera 180. The camera 180 and an image from the camera 180 are used for movement improvement of the autonomous moving apparatus 100, but are not used by the control unit 130 for movement control of the autonomous moving apparatus 100, and do not constitute a part of the movement control algorithm executed by the control unit 130.

### Example 1

In Example 1, an example will be described in which the movement control algorithm can be improved even in an environment where the autonomous moving apparatus 100 operates independently without being connected to the network 10 or other devices. As shown in FIG. 3, the autonomous moving apparatus 100 according to Example 1 includes a receiving device that receives a signal, a control unit 130 that causes the autonomous moving apparatus 100 to move, a camera 180 that captures an image of a periphery of the autonomous moving apparatus 100, and a movement improvement unit 190. The receiving device that receives a signal includes the receiving unit 110 that receives a radio wave signal and the information acquiring unit 150 that receives an acoustic wave signal. The signal includes the radio wave signal and the acoustic wave signal. The control unit 130 causes the autonomous moving apparatus 100 to move, based on the radio wave signal and the acoustic wave signal respectively received by the receiving device and an autonomous movement algorithm. The movement improvement unit 190 changes the autonomous movement algorithm, based on data of at least one of the radio wave signal and the acoustic wave signal among signals received by the receiving device, and the image captured by the camera 180.

With only the radio wave signal and the acoustic wave signal as movement results, it is difficult to understand what kind of place the autonomous moving apparatus 100 moved through and failed, what points should be improved, and the like. By combining an image captured by the camera 180 with the radio wave signal and the acoustic wave signal, the shape of an obstacle or the like can be clearly understood from the image, so that the movement result can be easily and accurately analyzed, and the movement control algorithm can be accurately improved.

The movement improvement unit 190 changes the autonomous movement algorithm by machine learning using data of at least one of the radio wave signal and the acoustic wave signal, and the image as input data. Machine learning includes deep learning. The movement improvement unit 190 may use a known machine learning method. According to Example 1, the autonomous moving apparatus 100 itself can improve the autonomous movement algorithm therein. It is possible to perform improvement of an autonomous movement algorithm that is different for each environment in which the autonomous moving apparatus 100 is used or for each autonomous moving apparatus 100. Therefore, the autonomous movement algorithm of the autonomous moving apparatus 100 can be customized for each user or for each use environment. The autonomous moving apparatus 100 of Example 1 and the movement improvement method thereof can be realized even in a stand-alone environment where the autonomous moving apparatus 100 is operated independently without being connected to a network or other devices. The movement improvement unit 190 can use, for example, an AI chip specialized for machine learning or deep learning.

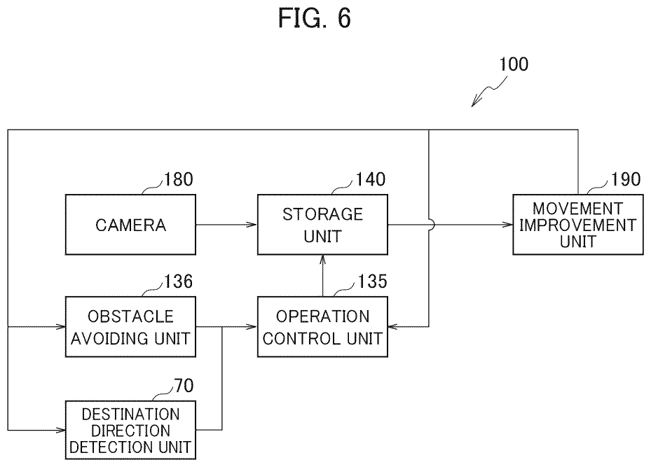

With reference to FIG. 6, an example of a data flow in the autonomous moving apparatus 100 according to Example 1 will be described. The autonomous moving apparatus 100 includes the camera 180, the storage unit 140, the obstacle avoiding unit 136, the operation control unit 135, a destination direction detection unit 70, and the movement improvement unit 190. The destination direction detection unit 70 is a functional block that executes a movement control algorithm related to the digital pheromone in the control unit 130, as shown in FIG. 3. Specifically, the destination direction detection unit 70 includes the phase difference determining unit 131, the reception intensity determining unit 132, the reception element selecting unit 133, and the angle estimating unit 134. Returning to FIG. 6, the movement control of the autonomous moving apparatus 100 is completed by the obstacle avoiding unit 136, the destination direction detection unit 70, and the operation control unit 135. The camera 180 is not used for the movement control of the autonomous moving apparatus 100.

The obstacle avoiding unit 136 stores at least an acoustic wave signal in the storage unit 140 as a result of movement control. The obstacle avoiding unit 136 may further store data related to echolocation, including a reliability degree (I) and a control signal obtained as a result of processing the acoustic wave signal, in the storage unit 140. The destination direction detection unit 70 stores at least a radio wave signal in the storage unit 140 as a result of movement control. The destination direction detection unit 70 may further store data related to the digital pheromone, including reception intensity of the radio wave signal and angle information of the radio wave obtained as a result of processing the radio wave signal, in the storage unit 140. Furthermore, the operation control unit 135 may store sensing data obtained as a result of processing the radio wave signal and the acoustic wave signal in the storage unit 140. Here, the “sensing data” includes movement direction information, a determination result of a reliability degree (I), reception intensity of a received signal, a time change of a signal, the number of reception times of a signal, a left-right comparison of a signal, a comparison with a past history, an estimated distance to an obstacle, a shape of an estimated space or passage, a noise amount of a signal, stability of an incoming direction angle, an index according to the reliability degree (I), and map information.

An image captured by the camera 180 is linked to data stored in the storage unit 140 from the obstacle avoiding unit 136, the destination direction detection unit 70, and the operation control unit 135. Specifically, data of a signal (a radio wave signal and an acoustic wave signal) and an image received or captured at the same time are linked. Data related to echolocation, data related to the digital pheromone, and sensing data, which are obtained as a result of processing the radio wave signal and the acoustic wave signal, are linked to the image using reception times of the original radio wave signal and acoustic wave signal. In this way, a signal received at the same time and a captured image can be collated. The shape of an obstacle, the shape of a passage, a space, or the like in the periphery of the autonomous moving apparatus 100 when the signal is received can be clearly grasped, which enables accurate movement improvement.

The autonomous moving apparatus 100 includes the camera 180 that captures an image of the periphery of the autonomous moving apparatus 100. The number of cameras 180 may be one or two or more. The camera 180 is installed so that a predetermined angle of view including a traveling direction (front) of the autonomous moving apparatus 100 is a capturing range. For example, the camera 180 is installed near a front end portion of the autonomous moving apparatus 100 in a plan view. Specifically, the camera 180 is arranged inside a collision prevention bumper. The camera 180 may be installed in the same direction as the speaker 41, and when a plurality of speakers 41 are provided, the same number of cameras 180 may be prepared, and the speaker 41 and the camera 180 may be paired. A center line of the angle of view of the camera 180 may be horizontal, or may be inclined downward by, for example, about 60 degrees. When the camera 180 is inclined downward, the camera 180 is attached to a high position of the autonomous moving apparatus 100. As a result, a wide range from around the collision prevention bumper in the traveling direction of the autonomous moving apparatus 100 to a far distance in the traveling direction, for example, up to about 1 m from the end in the traveling direction, can be captured by one camera, as compared with a case where the camera 180 is attached so that the center line of the angle of view is horizontal.

The camera 180 is a digital camera using an imaging element that converts light reception into an electric signal. The camera 180 may be a camera that captures a two-dimensional image, or a depth camera or a stereo camera that can also acquire depth information. The captured image is output as data and stored in the storage unit 140. The image is stored in the storage unit 140 in association with at least one of the radio wave signal and the acoustic wave signal. Time information such as a time stamp can be used for the association. Specifically, the image, the radio wave signal, and the acoustic wave signal are linked so that a time when a radio wave or an acoustic wave is received and a capturing time of the image match. Instead of a time stamp, information indicating the radio wave signal and the acoustic wave signal may be displayed in the image. A sensing result by the control unit 130, vehicle control information, and a movement state of the autonomous moving apparatus 100 may be added to the association. The sensing result includes reception intensity of a radio wave signal, an incoming angle of a radio wave, a reliability degree (I), a relative direction of an obstacle and a relative distance to the obstacle, contact prediction information, and contact information. The vehicle control information includes information indicating a movement direction and a movement speed of the autonomous moving apparatus 100. As a method of association, instead of a time stamp, the above-described information (radio wave signal, acoustic wave signal, sensing result, vehicle control information, movement state) may be displayed on an image together with time information.

### Example 2

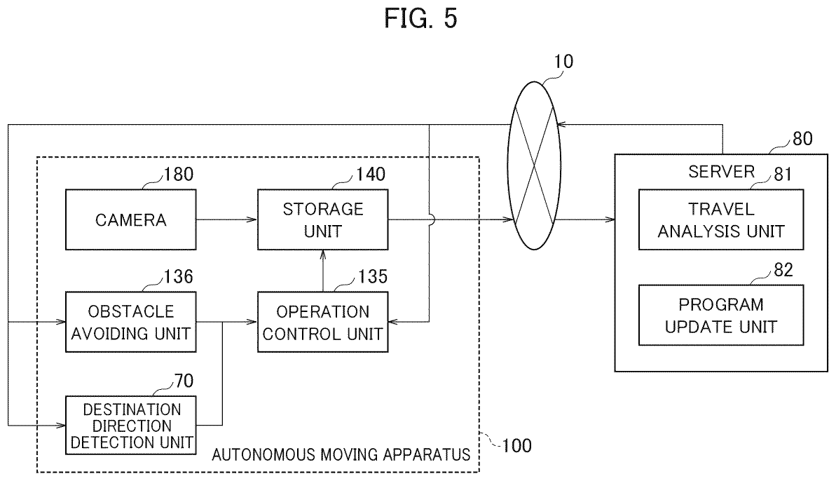

In Example 2, with reference to FIG. 5, an autonomous movement system will be described, in which one or more autonomous moving apparatuses 100 are connected to a server 80 via a network 10, and the server 80 improves a movement control algorithm of the one or more autonomous moving apparatuses 100. The autonomous movement system has one or more autonomous moving apparatuses 100, and a server 80 communicably connected to the one or more autonomous moving apparatuses 100. A configuration of each autonomous moving apparatus 100 is the same as the configuration of the autonomous moving apparatus 100 of FIG. 6, except that the movement improvement unit 190 of FIG. 6 is not provided, and thus a description thereof will be omitted.

The server 80 includes a travel analysis unit 81 and a program update unit 82. The server 80 receives data of a radio wave signal and an acoustic wave signal received by each autonomous moving apparatus 100 and an image captured by the camera 180. Data of at least one of the radio wave signal and the acoustic wave signal and the image stored in the storage unit 140 of each autonomous moving apparatus 100 are uploaded to the server 80 via the network 10 in a state of being associated with each other. Data of at least one of the radio wave signal and the acoustic wave signal and the image transmitted from two or more autonomous moving apparatuses 100 to the server 80 correspond to big data. A manufacturer of the autonomous moving apparatus 100 or a provider of an autonomous movement improvement service identifies data of at least one of the radio wave signal and the acoustic wave signal and the image in a predetermined movement state of the autonomous moving apparatus 100 to be subjected to movement improvement from the big data. That is, control history data and an image when the autonomous moving apparatus 100 could not move well are extracted as control history data and an image to be improved.

The travel analysis unit 81 analyzes the movement of the autonomous moving apparatus 100 based on the control history data and the image to be improved. A specific analysis method will be described later as a specific example of movement improvement. The program update unit 82 updates an autonomous movement program, which is an example of an autonomous movement algorithm, based on an analysis result. The updated autonomous movement program is downloaded from the server 80 to the operation control unit 135, the obstacle avoiding unit 136, and the destination direction detection unit 70, respectively. In this way, the autonomous movement system of Example 2 can simultaneously perform movement improvement common to all the autonomous moving apparatuses 100, based on big data (signal data and images) collected from an unspecified number of autonomous moving apparatuses 100. The autonomous movement system can centrally and efficiently perform movement improvement common to one or more autonomous moving apparatuses 100 in the server 80.

In Example 2, a manufacturer of the autonomous moving apparatus 100 or a provider of an autonomous movement improvement service, that is, a person, may identify control history data and an image in a predetermined operation state to be improved from big data, by collating the signal data and the image. Alternatively, the server 80 may identify the control history data and the image using an image recognition technology. Furthermore, as in Example 1, the server 80 may identify data of a signal and an image in a predetermined operation state to be improved using an AI chip specialized for machine learning or deep learning, and execute movement improvement.

### Specific Example of Movement Improvement

Next, an example of a predetermined operation state of the autonomous moving apparatus 100 to be improved and an example of improvement of a movement control algorithm in the predetermined operation state will be described.

<Collision with Obstacle>

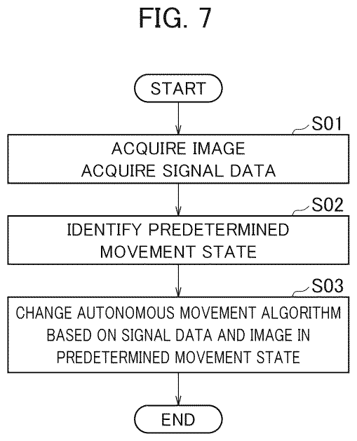

An example of a predetermined operation state of the autonomous moving apparatus 100 to be improved is a collision with an obstacle. Since it is difficult to accurately grasp the shape of an obstacle only from a radio wave and an acoustic wave, the autonomous moving apparatus 100 may collide with (including contact) an obstacle. First, as shown in FIG. 7, in step S01, data of at least one of a radio wave signal and an acoustic wave signal and an image are acquired from the storage unit 140. The data of at least one of the radio wave and the acoustic wave may be simply referred to as “signal data.” The processing proceeds to step S02, and data of a signal and an image before and after the autonomous moving apparatus 100 collides with an obstacle are identified as data of a signal and an image in a predetermined movement state. For collision detection with an obstacle, a collision prevention bumper to which a bumper sensor is attached can be used. Alternatively, the processing of step S02 may be performed by a person based on an image, or may be performed by the movement improvement unit 190 or the server 80 using an image processing technology. Sensing data, a sensing result by the control unit 130, and vehicle control information obtained as a result of processing the signal data, which are linked to the identified signal data, may be further identified.

The processing proceeds to step S03, and the autonomous movement algorithm is changed using the identified signal data and image. As an example of changing the autonomous movement algorithm, at least one of a threshold value and a coefficient used for a determination to avoid a collision between the autonomous moving apparatus 100 and an obstacle may be changed. For example, signal data and an image for 10 seconds before and after a collision are identified. It is found from an image or a detection result of a bumper sensor that the autonomous moving apparatus 100 has collided with a thin pole (obstacle). At least one of a determination threshold value or a coefficient related to echolocation or a digital pheromone is changed so that the thin pole can be recognized by an acoustic wave or a radio wave from a shape such as a width of the thin pole. For example, by lowering a threshold value for obstacle detection determination, a thin pole with a small intensity of a reflected wave of an acoustic wave can be detected. Alternatively, at least one of a determination threshold value or a coefficient may be changed so that a sensing frequency of echolocation becomes higher. Specifically, a sensing cycle is shortened without changing a movement speed, a movement speed is lowered without changing a sensing cycle, or a movement speed is lowered and a sensing cycle is shortened. As a result, a thin pole can be detected using a radio wave or an acoustic wave.

### <Crowded State>

Another example of a predetermined operation state of the autonomous moving apparatus 100 to be improved is a crowded state. In step S02, signal data and an image in a crowded state are identified as signal data and an image in a predetermined movement state, using an image. A state in which a predetermined number or more of people are in the periphery of the autonomous moving apparatus 100 is referred to as a “crowded state.” For example, signal data and an image for 10 seconds before and after the autonomous moving apparatus 100 enters a crowd are identified.

In step S03, the autonomous movement algorithm can be changed to avoid a crowd, using the signal data and the image in the crowded state. First, signal data before entering the crowd is compared with signal data after entering the crowd, that is, signal data in the crowded state. As a result, a noise component caused by a person included in the signal data can be identified. Various radio wave signals generated from a person or an electronic device carried by a person and acoustic wave signals such as conversation and shoe sounds correspond to noise components caused by a person. The movement control algorithm of the control unit 130 is changed so that a direction different from an incoming direction of a signal having a noise component caused by a person is determined as a movement direction of the autonomous moving apparatus 100, in response to reception of the signal having the noise component caused by a person. As a result, the autonomous movement algorithm can be changed to avoid a crowd.

Alternatively, in step S03, the autonomous movement algorithm may be changed so that a crowd can be passed through, using the signal data and the image in the crowded state. First, in the same manner as in the case of avoidance, a noise component caused by a person included in the signal data is identified. The movement control algorithm of the control unit 130 is changed so that, in response to a noise component caused by a person among received acoustic wave signals exceeding a certain value, movement control is performed based only on a radio wave signal without using an acoustic wave signal for a certain period thereafter. That is, the movement control algorithm is changed so that an echolocation function is stopped and movement control is performed using only a digital pheromone function and a collision detection function. The autonomous movement algorithm may be changed to remove a noise component caused by a person from signal data, in response to the noise component caused by a person exceeding a certain value. The autonomous movement algorithm may be changed to lower a coefficient that contributes to autonomous movement of a signal having a noise component caused by a person, in response to the noise component caused by a person exceeding a certain value. Alternatively, the autonomous movement algorithm may be changed to perform movement control using signal data before a noise component caused by a person exceeds a certain value, in response to the noise component caused by a person exceeding the certain value. As a result, the autonomous movement algorithm can be changed so that the autonomous moving apparatus 100 can pass through a crowd.

### <State of not Passing Through Passable Passage>

Another example of a predetermined operation state of the autonomous moving apparatus 100 to be improved is a state of not passing through a passable passage. For example, in response to a device that emits an acoustic wave or a radio wave being installed at an entrance of a passage that can originally be passed through, the autonomous moving apparatus 100 mistakenly recognizes that the passage cannot be passed through, and chooses another passage, resulting in a detour to the target object 200.

Therefore, in step S02, a state of not passing through a passage that can originally be passed through is identified using an image. That is, signal data and an image when a passage that can originally be passed through was not passed through are identified. For example, a person identifies a scene in which a passage that can originally be passed through was not passed through while looking at an image. In step S03, the autonomous movement algorithm is changed so that the passage is passed through. For example, the autonomous movement algorithm may be changed so that movement control is executed without considering these unnatural signals when an acoustic wave different from an acoustic wave transmitted by the autonomous moving apparatus 100 or a radio wave having a frequency different from a radio wave output from the target object 200 is received. Also, when an acoustic wave different from an acoustic wave transmitted by the autonomous moving apparatus 100 is received, the autonomous movement algorithm may be changed so that an echolocation function is turned off and movement control is performed using only a radio wave signal and a collision prevention function. As a result, a passable passage can be passed through. The autonomous moving apparatus 100 can move in a room or a passage where a device that outputs an acoustic wave is located.

When a width of a passage has a small margin with respect to a size in a width direction of the autonomous moving apparatus 100, that is, when the autonomous moving apparatus 100 can barely pass through the passage, the autonomous moving apparatus 100 should originally determine that it can pass through, but since the shape of an obstacle cannot be clearly recognized only by an acoustic wave and a radio wave, the autonomous moving apparatus 100 determines that it cannot pass through. In step S02, a state of not passing through a passage that can originally be passed through is identified using an image. Specifically, a person estimates a width of a passage while looking at an image, and identifies a scene in which the autonomous moving apparatus 100 did not pass through a passage that it could barely pass through. In step S03, a sensitivity (parameter) of the autonomous moving apparatus 100 to an obstacle is lowered so that the passage can be passed through. As a result, the autonomous movement algorithm is changed, and the autonomous moving apparatus 100 can autonomously pass through a passage that it can barely pass through.

When the autonomous moving apparatus 100 passes through an automatic door, the autonomous moving apparatus 100 may mistakenly recognize that it cannot pass through, although it should originally determine that it can pass through. The autonomous moving apparatus 100 detects a closed automatic door from a distance, and determines that the automatic door is an obstacle that cannot be passed through. After that, even if the autonomous moving apparatus 100 approaches the automatic door and the automatic door opens, the autonomous moving apparatus 100 regards the automatic door as an obstacle and passes by it. Such a scene can occur when a sensing frequency of the autonomous moving apparatus 100 is low.

Therefore, by increasing the sensing frequency, the autonomous moving apparatus 100 can detect an open automatic door and recognize the automatic door as a passable passage. Therefore, the autonomous moving apparatus 100 can pass through the automatic door. In step S02, a movement state of not passing through an open automatic door is identified using an image. In step S03, the autonomous movement algorithm is changed so that the open automatic door is passed through. For example, at least one of a determination threshold value or a coefficient is changed so that an obstacle sensing frequency becomes higher. Specifically, around an automatic door, a sensing cycle is shortened without changing a movement speed, a movement speed is lowered without changing a sensing cycle, or a movement speed is lowered and a sensing cycle is shortened. As a result, the autonomous moving apparatus 100 can detect and pass through an open automatic door.

When the autonomous moving apparatus 100 is directly facing a surface with high flatness, a reflected wave from the surface received by the autonomous moving apparatus 100 becomes strong. If an angle of the surface with respect to the autonomous moving apparatus 100 changes even slightly, the intensity of the reflected wave decreases rapidly. The autonomous moving apparatus 100 may temporarily react sensitively to a strong signal and determine that there is a large obstacle. Therefore, the autonomous movement algorithm is changed so that the sensing frequency becomes higher. As a result, it is possible to determine that it is a small obstacle, and robust movement becomes possible. Alternatively, the autonomous movement algorithm may be changed so that movement control is performed using a moving average of time-series data including a radio wave signal and an acoustic wave signal.

### <State of not Approaching Target Object 200>

Another example of a predetermined operation state of the autonomous moving apparatus 100 to be improved is a state in which the autonomous moving apparatus 100 is not approaching the target object 200. In step S02, signal data and an image in a state in which the autonomous moving apparatus 100 is not approaching the target object 200 are identified. Specifically, when a time change of intensity of a radio wave signal received from the target object 200 is smaller than a predetermined value, a time change of a distance from the autonomous moving apparatus 100 to the target object 200 is also small. Although a state of not passing through a passage that can originally be passed through is identified using an image, a state of not approaching the target object 200 can be identified by means other than an image. Therefore, the autonomous moving apparatus 100 including the movement improvement unit 190 shown in FIG. 6 can improve the autonomous movement algorithm so that the autonomous moving apparatus 100 can approach the target object 200.

In step S02, a state of wandering around in front of an entrance of a specific passage (wandering state) is identified. A signal data and an image in the wandering state are identified from the signal data and the image acquired in step S01. The identification may be performed using an image, or may be performed from a time change of reception intensity of a radio wave signal received from the target object 200.

In step S03, machine learning is performed using the signal data and the image in the wandering state as input data, and the movement control algorithm is changed. For example, a speed when traveling in front of a specific passage is reduced. As a result, movement control using more detailed sensing data becomes possible, so that the autonomous movement algorithm can be improved so that the autonomous moving apparatus 100 can approach the target object 200 by passing through the specific passage.

The above-described embodiments are examples of the present invention. For this reason, the present invention is not limited to the above-described embodiments, and it is needless to say that various modifications can be made according to a design or the like, as long as the modifications do not depart from the technical idea of the present invention, even in a form other than the embodiments.

### (Supplementary Note 1)

Provided is a movement improvement method for an autonomous moving apparatus 100 that autonomously moves based on a received signal and an autonomous movement algorithm, the method comprising: acquiring data of a signal received by the autonomous moving apparatus 100 and an image captured by a camera 180 mounted on the autonomous moving apparatus 100; identifying the data of the signal and the image in a predetermined movement state of the autonomous moving apparatus 100; and changing the autonomous movement algorithm of the autonomous moving apparatus 100, based on the identified data of the signal and the image. By combining an image captured by the camera 180 with the data of the signal, the shape of an obstacle or the like can be clearly understood from the image, so that the movement result can be easily and accurately analyzed, and the movement control algorithm can be accurately improved.

### (Supplementary Note 2)

Provided is the movement improvement method for an autonomous moving apparatus 100 according to Supplementary note 1, the method comprising: identifying the data of the signal and the image before and after the autonomous moving apparatus 100 collides with obstacles J1, J2, and p1 to p4, as the data of the signal and the image in the predetermined movement state; and changing at least one of a threshold value and a coefficient used for a determination to avoid a collision between the autonomous moving apparatus 100 and the obstacles J1, J2, and p1 to p4s, using the identified data of the signal and the image. The autonomous movement algorithm can be accurately improved so that a collision with the obstacles J1, J2, and p1 to p4s can be avoided.

### (Supplementary Note 3)

Provided is the movement improvement method for an autonomous moving apparatus 100 according to Supplementary note 1, the method comprising: identifying, using an image, data of a signal and an image in a crowded state in which a predetermined number or more of people are in a periphery of the autonomous moving apparatus 100, as the data of the signal and the image in the predetermined movement state; and changing the autonomous movement algorithm to avoid a crowd, using the data of the signal and the image in the crowded state. The autonomous movement algorithm can be accurately improved to avoid a crowded state.

### (Supplementary Note 4)

Provided is the movement improvement method for an autonomous moving apparatus 100 according to Supplementary note 1, the method comprising: identifying, using an image, data of a signal and an image in a crowded state in which a predetermined number or more of people are in a periphery of an autonomous moving vehicle, as the data of the signal and the image in the predetermined movement state; and changing the autonomous movement algorithm to remove a noise component caused by a person from the data of the signal, or to lower a coefficient that contributes to autonomous movement of the signal having the noise component caused by a person, using the data of the signal and the image in the crowded state. The autonomous movement algorithm can be accurately improved to pass through a crowded state.

### (Supplementary Note 5)

Provided is the movement improvement method for an autonomous moving apparatus 100 according to Supplementary note 1, the method comprising: identifying data of a signal and an image in a state in which the autonomous moving apparatus 100 does not pass through a passable passage, as the data of the signal and the image in the predetermined movement state; and changing the autonomous movement algorithm to pass through the passage, using the data of the signal and the image in the state of not passing through the passable passage. The autonomous movement algorithm can be accurately improved to pass through a passable passage.

### (Supplementary Note 6)

Provided is the movement improvement method for an autonomous moving apparatus 100 according to Supplementary note 1, the method comprising: identifying data of a signal and an image in a state in which the autonomous moving apparatus 100 is not approaching a target object 200, as the data of the signal and the image in the predetermined movement state; and changing the autonomous movement algorithm to approach the target object 200, using the data of the signal and the image in the state of not approaching the target object 200. The autonomous movement algorithm can be accurately improved to approach the target object 200.

### (Supplementary Note 7)

Provided is the movement improvement method for an autonomous moving apparatus 100 according to Supplementary note 6, the method comprising: changing the autonomous movement algorithm to approach the target object 200 by machine learning using data of a signal and an image in a state in which the autonomous moving apparatus 100 is not approaching the target object 200, as input data. The autonomous moving apparatus 100 itself can improve the autonomous movement algorithm therein to approach the target object 200.

### (Supplementary Note 8)

Provided is the movement improvement method for an autonomous moving apparatus 100 according to any one of Supplementary notes 1 to 7, wherein the identified data of the signal and the image are the data of the signal and the image received or captured at the same time. Since an image captured when a signal is received can clearly grasp the data of the signal, movement can be accurately improved.

### (Supplementary Note 9)

Provided is the movement improvement method for an autonomous moving apparatus 100 according to any one of Supplementary notes 1 to 8, wherein the data of the signal and the image are acquired from a plurality of autonomous moving apparatuses 100. Movement improvement common to two or more autonomous moving apparatuses 100 can be centrally and efficiently performed in the server 80.

### (Supplementary Note 10)

Provided is an autonomous moving apparatus 100 including: a receiving device that receives a signal; a control unit 130 that causes the autonomous moving apparatus 100 to move, based on the signal received by the receiving device and an autonomous movement algorithm; a camera 180 that captures an image of a periphery of the autonomous moving apparatus 100; and a movement improvement unit 190 that changes the autonomous movement algorithm, based on data of the signal received by the receiving device and the image captured by the camera 180. By combining an image captured by the camera 180 with the data of the signal, the shape of an obstacle or the like can be clearly understood from the image, so that the movement result can be easily and accurately analyzed, and the movement control algorithm can be accurately improved.

### (Supplementary Note 11)

Provided is the autonomous moving apparatus 100 according to Supplementary note 10, wherein the movement improvement unit 190 changes the autonomous movement algorithm by machine learning using the data of the signal and the image as input data. The autonomous moving apparatus 100 itself can improve the autonomous movement algorithm therein.

### (Supplementary Note 12)

Provided is an autonomous movement system including: one or more autonomous moving apparatuses 100; and a server 80 communicably connected to the one or more autonomous moving apparatuses 100 via a network 10, wherein each of the autonomous moving apparatuses 100 includes: a receiving device that receives a signal; a control unit 130 that causes the autonomous moving apparatus 100 to move, based on the signal received by the receiving device and an autonomous movement algorithm; and a camera 180 that captures an image of a periphery of the autonomous moving apparatus 100, and the server receives, from the one or more autonomous moving apparatuses 100, data of the signal received by the receiving device and the image captured by the camera 180, changes the autonomous movement algorithm based on the data of the signal received by the receiving device and the image captured by the camera 180, and transmits the changed autonomous movement algorithm to the one or more autonomous moving apparatuses 100. The autonomous movement system can centrally and efficiently perform movement improvement common to two or more autonomous moving apparatuses 100 in the server 80.

### (Supplementary Note 13)

Provided is the autonomous movement system according to Supplementary note 12, wherein the server 80 changes the autonomous movement algorithm by machine learning using the data of the signal and the image as input data. The server 80 can improve the autonomous movement algorithm therein.

### REFERENCE SIGNS LIST

10 Network, 80 Server, 100 Autonomous moving apparatus, 110 Receiving unit (receiving device), 150 Information acquiring unit (receiving device), 180 Camera, 190 Movement improvement unit, J1, J2, p1 to p4 Obstacle

1. A movement improvement method for an autonomous moving apparatus that autonomously moves based on a received signal and an autonomous movement algorithm, the method comprising:
acquiring data of the signal received by the autonomous moving apparatus and an image captured by a camera mounted on the autonomous moving apparatus;
identifying the data of the signal and the image in a predetermined movement state of the autonomous moving apparatus; and
changing the autonomous movement algorithm of the autonomous moving apparatus, based on the identified data of the signal and the image.

2. The movement improvement method for an autonomous moving apparatus according to claim 1, comprising:
identifying the data of the signal and the image before and after the autonomous moving apparatus collides with an obstacle, as the data of the signal and the image in the predetermined movement state; and
changing at least one of a threshold value and a coefficient used for a determination to avoid a collision between the autonomous moving apparatus and the obstacle, using the identified data of the signal and the image.

3. The movement improvement method for an autonomous moving apparatus according to claim 1, comprising:
identifying, using the image, data of the signal and the image in a crowded state in which a predetermined number or more of people are in a periphery of the autonomous moving apparatus, as the data of the signal and the image in the predetermined movement state; and
changing the autonomous movement algorithm to avoid a crowd, using the data of the signal and the image in the crowded state.

4. The movement improvement method for an autonomous moving apparatus according to claim 1, comprising:
identifying, using the image, data of the signal and the image in a crowded state in which a predetermined number or more of people are in a periphery of an autonomous moving vehicle, as the data of the signal and the image in the predetermined movement state; and
changing the autonomous movement algorithm to remove a noise component caused by a person from the data of the signal, or to lower a coefficient that contributes to autonomous movement of the signal having the noise component caused by a person, using the data of the signal and the image in the crowded state.

5. The movement improvement method for an autonomous moving apparatus according to claim 1, comprising:
identifying data of the signal and the image in a state in which the autonomous moving apparatus does not pass through a passable passage, as the data of the signal and the image in the predetermined movement state; and
changing the autonomous movement algorithm to pass through the passage, using the data of the signal and the image in the state of not passing through the passable passage.

6. The movement improvement method for an autonomous moving apparatus according to claim 1, comprising:
identifying data of the signal and the image in a state in which the autonomous moving apparatus is not approaching a target object, as the data of the signal and the image in the predetermined movement state; and
changing the autonomous movement algorithm to approach the target object, using the data of the signal and the image in the state of not approaching the target object.

7. The movement improvement method for an autonomous moving apparatus according to claim 6, comprising:
changing the autonomous movement algorithm to approach the target object by machine learning using data of the signal and the image in a state in which the autonomous moving apparatus is not approaching the target object, as input data.

8. The movement improvement method for an autonomous moving apparatus according to claim 1, wherein the identified data of the signal and the image are the data of the signal and the image received or captured at the same time.

9. The movement improvement method for an autonomous moving apparatus according to claim 1, wherein the data of the signal and the image are acquired from a plurality of autonomous moving apparatuses.

10. An autonomous moving apparatus comprising:
a receiving device that receives a signal;
a control unit that causes the autonomous moving apparatus to move, based on the signal received by the receiving device and an autonomous movement algorithm;
a camera that captures an image of a periphery of the autonomous moving apparatus; and
a movement improvement unit that changes the autonomous movement algorithm, based on data of the signal received by the receiving device and the image captured by the camera.

11. The autonomous moving apparatus according to claim 10, wherein the movement improvement unit changes the autonomous movement algorithm by machine learning using the data of the signal and the image as input data.

12. An autonomous movement system comprising: one or more autonomous moving apparatuses; and a server communicably connected to the one or more autonomous moving apparatuses via a network, wherein
each of the autonomous moving apparatuses includes:
a receiving device that receives a signal;
a control unit that causes the autonomous moving apparatus to move, based on the signal received by the receiving device and an autonomous movement algorithm; and
a camera that captures an image of a periphery of the autonomous moving apparatus, and
the server
receives, from the one or more autonomous moving apparatuses, data of the signal received by the receiving device and the image captured by the camera,
changes the autonomous movement algorithm based on the data of the signal received by the receiving device and the image captured by the camera, and
transmits the changed autonomous movement algorithm to the one or more autonomous moving apparatuses.

13. The autonomous movement system according to claim 12, wherein the server changes the autonomous movement algorithm by machine learning using the data of the signal and the image as input data.
